(19) United States
(12) Patent Application Publication
(10) Pub. No.: US 2023/0217897 A1
(43) Pub. Date: Jul. 13, 2023

(54) APPARATUS FOR DISPENSING PET TREATS

(71) Applicant: Felix YIM, Richmond, CA (US)

(72) Inventors: Felix YIM, Richmond (CA); Henry YU, Edmonton (CA)

(21) Appl. No.: 18/095,927

(22) Filed: Jan. 11, 2023

Related U.S. Application Data
(60) Provisional application No. 63/298,377, filed on Jan. 11, 2022.

(51) Int. Cl. A01K 15/02

(52) U.S. Cl. CPC A01K 15/02

(57) ABSTRACT

A dispenser has an upper housing and a base. The upper housing has an upper housing enclosure for holding pet treats. The base has a lower housing and a dispensing member that slides within the lower housing. The lower housing has a lower housing enclosure. A spring biases the dispensing member between a first (closed) and a second (open) position. When the dispensing member is in the first position, items are able to travel from the upper housing enclosure, into the lower housing enclosure, and into a dispenser enclosure within the dispensing member. When the dispensing member is moved to the second position, items within the dispenser enclosure may be dispensed from the dispenser. The lower housing and the dispensing member may include blades to sever items that protrude from the dispenser enclosure when the dispenser member is moved from the first position to the second position.

### CROSS-REFERENCE TO RELATED APPLICATIONS

This application claims the benefit of U.S. Provisional Patent Application No. 63/298,377 filed Jan. 11, 2022, the contents of which are hereby incorporated by reference.

### FIELD OF THE INVENTION

The present invention relates to apparatuses for dispensing items, such as pet treats.

### BACKGROUND OF THE INVENTION

Pet treats are commonly given to pets as a reward for good behaviour. In addition, pet treats are also used during pet training. It is known to use portable treat dispensers for carrying and dispensing pet treats. Such treat dispensers typically comprise a container for holding pet treats and some mechanism for dispensing the pet treats in a controlled manner.

One such example of a pet treat dispenser is disclosed in U.S. Pat. No. 7,143,719 to Giddens et al. A drawback of the pet treat dispenser disclosed in Giddens et al. is that the pet treats may sometimes jam the dispensing mechanism, thereby preventing further pet treats from being dispensed.

It is therefore an objective of the invention to provide an improved pet treat dispenser that addresses such a drawback. This and other objectives will become apparent from the following description of the invention.

### SUMMARY OF THE INVENTION

In accordance with one embodiment of the invention, an item dispenser comprises an upper housing and a base that are removably attached to each other. The upper housing comprises an upper housing enclosure for holding items, such as pet treats. The base comprises a lower housing and a dispensing member that is configured to slide within the lower housing. The lower housing also comprises a lower housing enclosure that is contiguous with the upper housing enclosure. A spring member biases the dispensing member between a first (closed) and a second (open) position.

When the dispensing member is in the first (closed) position, items are able to travel from the upper housing enclosure, into the lower housing enclosure, and into a dispenser enclosure within the dispensing member. When the dispensing member is moved to the second (open) position, items within the dispenser enclosure may be dispensed from the dispenser. One or both of the lower housing and the dispensing member may comprise blades. The blades are adapted to sever any items that protrude from the dispenser enclosure when the dispenser member is moved from the first (closed) position to the second (open) position, thereby preventing jamming of the dispensing member by items that are too large for the dispenser enclosure.

In accordance with an embodiment of the invention, a dispenser for dispensing items comprises an upper housing and a base. The upper housing is adapted to enclose the items. The base is removably attached to the upper housing, and the base comprises a lower housing, a dispensing member, and one or more spring members. The lower housing comprises a lower enclosure, a first blade member, and a bottom wall. The lower enclosure comprises an upper opening at one end thereof and a lower opening at another end thereof. The upper opening is adapted to receive the items from the upper housing into the lower enclosure. The first blade member extends across at least a portion of the lower opening. The bottom wall comprises a bottom opening formed thereon, with the bottom opening not in alignment with the lower opening. The dispensing member is adapted to move longitudinally within the lower housing, with the dispensing member comprising a dispenser enclosure and a second blade member. The dispenser enclosure comprises a dispenser upper opening at one end thereof and a dispenser lower opening at another end thereof. The second blade member extends across at least a portion of the dispenser upper opening. The one or more spring members connect the dispensing member to the lower housing and are adapted to allow the dispensing member to move from a first position to a second position, and vice versa, with respect to the lower housing. In the first position, the lower opening is, at least partially, aligned with the dispenser upper opening to allow the items to enter into the dispenser enclosure from the lower enclosure. In the second position, the dispenser lower opening is, at least partially, aligned with the bottom opening to allow the items to exit from the dispenser enclosure through dispenser lower opening and the bottom opening.

In a further embodiment, a movement of the dispensing member from the first position to the second position causes the second blade member to slide past the first blade member and to sever any of the items that are within both of the lower enclosure and the dispenser enclosure.

In still a further embodiment, the lower housing further comprises first and second housing members. The lower enclosure is located between the first and second housing members.

In another embodiment, the first and second housing members comprise upper surfaces. The upper surfaces are adapted to direct the items towards the upper opening.

In still another embodiment, the upper surfaces comprise one or more angled surfaces.

In still yet another embodiment, the upper surfaces comprise one or more curved surfaces.

In a further embodiment, the upper opening is, at least partially, aligned with the lower opening.

In still a further embodiment, the dispenser upper opening is, at least partially, aligned with the dispenser lower opening.

In another embodiment, the lower housing further comprises a channel adapted to accommodate the dispensing member. The dispensing member is adapted to move from the first position to the second position, and vice versa, through longitudinal movement within the channel.

In yet another embodiment, the one or more spring members bias the dispensing member to the first position when the one or more spring members are uncompressed.

In still yet another embodiment, a compression of the one or more spring members causes the dispensing member to move from the first position to the second position.

In a further embodiment, the lower housing further comprises opposed lower sidewalls and a lower end wall extending between the lower sidewalls. The bottom wall extends between the lower sidewalls. The channel is defined, at least in part, by portions of the lower sidewalls, the bottom wall, and the lower end wall.

In still a further embodiment, the one or more spring members comprise first and second spring ends. The first spring ends are connected to the lower end wall, and the second spring ends are connected to the dispensing member.

In still yet another embodiment, the first blade member comprises a first cutting edge, the second blade member comprises a second cutting, and the movement of the dispensing member from the first position to the second position causes the second cutting edge to slide past the first cutting edge.

In accordance with an embodiment of the invention, a dispenser for dispensing items comprises an upper housing and a base. The upper housing is adapted to enclose the items. The base is removably attached to the upper housing, and the base comprises a lower housing, a dispensing member, and one or more spring members. The lower housing comprises a lower enclosure and a bottom wall. The lower enclosure comprises an upper opening at one end thereof and a lower opening at another end thereof. The upper opening is adapted to receive the items from the upper housing into the lower enclosure. The bottom wall comprises a bottom opening formed thereon, with the bottom opening not in alignment with the lower opening. The dispensing member is adapted to move longitudinally within the lower housing, with the dispensing member comprising a dispenser enclosure and a blade member. The dispenser enclosure comprises a dispenser upper opening at one end thereof and a dispenser lower opening at another end thereof. The blade member extends across at least a portion of the dispenser upper opening. The one or more spring members connect the dispensing member to the lower housing and are adapted to allow the dispensing member to move from a first position to a second position, and vice versa, with respect to the lower housing. In the first position, the lower opening is, at least partially, aligned with the dispenser upper opening to allow the items to enter into the dispenser enclosure from the lower enclosure. In the second position, the dispenser lower opening is, at least partially, aligned with the bottom opening to allow the items to exit from the dispenser enclosure through dispenser lower opening and the bottom opening.

In another embodiment, a movement of the dispensing member from the first position to the second position causes the blade member to slide across the lower opening and to sever any of the items that are within both of the lower enclosure and the dispenser enclosure.

In still another embodiment, the blade member comprises a cutting edge, and the movement of the dispensing member from the first position to the second position causes the cutting edge to slide across the lower opening.

In accordance with an embodiment of the invention, a dispenser for dispensing items comprises an upper housing and a base. The upper housing is adapted to enclose the items. The base is removably attached to the upper housing, and the base comprises a lower housing, a dispensing member, and one or more spring members. The lower housing comprises a lower enclosure, a blade member, and a bottom wall. The lower enclosure comprises an upper opening at one end thereof and a lower opening at another end thereof. The upper opening is adapted to receive the items from the upper housing into the lower enclosure. The blade member extends across at least a portion of the lower opening. The bottom wall comprises a bottom opening formed thereon, with the bottom opening not in alignment with the lower opening. The dispensing member is adapted to move longitudinally within the lower housing, with the dispensing member comprising a dispenser enclosure. The dispenser enclosure comprises a dispenser upper opening at one end thereof and a dispenser lower opening at another end thereof. The one or more spring members connect the dispensing member to the lower housing and are adapted to allow the dispensing member to move from a first position to a second position, and vice versa, with respect to the lower housing. In the first position, the lower opening is, at least partially, aligned with the dispenser upper opening to allow the items to enter into the dispenser enclosure from the lower enclosure. In the second position, the dispenser lower opening is, at least partially, aligned with the bottom opening to allow the items to exit from the dispenser enclosure through dispenser lower opening and the bottom opening.

In another embodiment, a movement of the dispensing member from the first position to the second position causes the blade member to slide across the dispenser upper opening and to sever any of the items that are within both of the lower enclosure and the dispenser enclosure.

In still another embodiment, the blade member comprises a cutting edge, and wherein the movement of the dispensing member from the first position to the second position causes the cutting edge to slide across the dispenser upper opening.

The foregoing was intended as a summary only and of only some of the aspects of the invention. It was not intended to define the limits or requirements of the invention. Other aspects of the invention will be appreciated by reference to the detailed description of the preferred embodiments.

### BRIEF DESCRIPTION OF THE DRAWINGS

The invention will be described by reference to the detailed description of the embodiments and to the drawings thereof in which:

FIG. 1 shows the dispenser in accordance with one embodiment of the invention;

FIG. 2 shows a perspective view of the upper housing of the dispenser of FIG. 1;

FIG. 3 shows another perspective view of the upper housing of FIG. 2;

FIG. 4 shows a perspective view of the base of the treat dispenser of FIG. 1;

FIG. 5 shows another perspective view of the base of FIG. 4;

FIG. 6 shows a top view of the base of FIG. 4;

FIG. 7 shows a bottom view of the base of FIG. 4;

FIG. 8 shows an exploded view of the base of FIG. 4;

FIG. 9 shows another exploded view of the base of FIG. 4;

FIG. 10 shows yet another exploded view of the base of FIG. 4;

FIG. 11 shows a partial view of the base of FIG. 4, viewed from the top;

FIG. 12 shows another partial view of the base of FIG. 4, viewed from the bottom;

FIG. 13 shows an exploded view of the dispenser;

FIG. 14 shows another exploded view of the dispenser;

FIG. 15 shows a cross-sectional view of the dispenser in the first (closed) position;

FIG. 16 shows a cross-sectional view of the dispenser in the second (open) position;

FIG. 17 shows an embodiment of the lower housing; and

FIG. 18 is another view of the embodiment of FIG. 17.

### DETAILED DESCRIPTION OF THE INVENTION

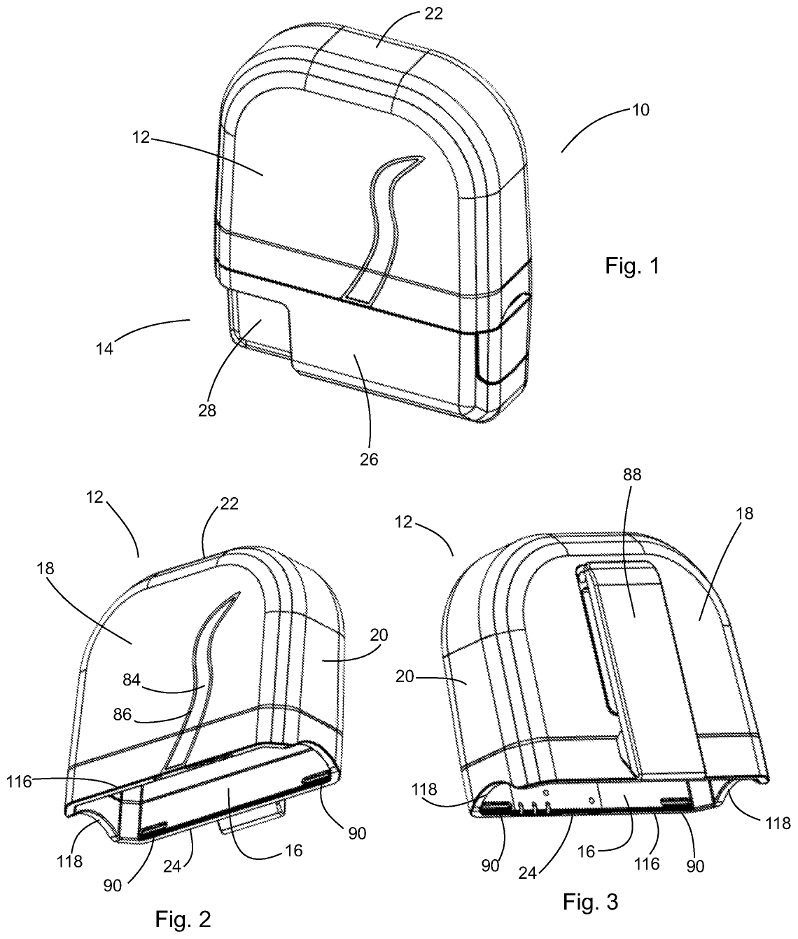

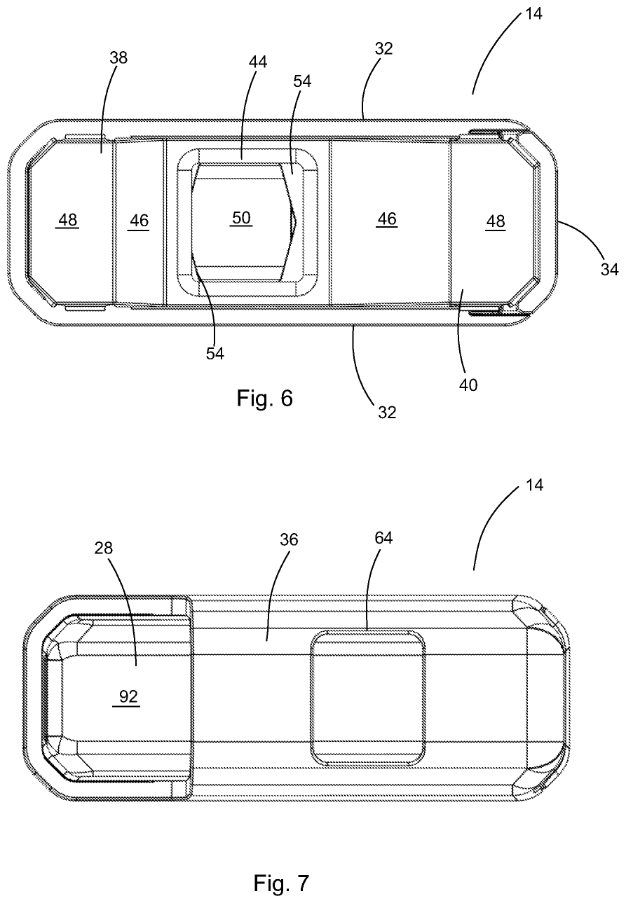

Referring to FIGS. 1 to 10, in accordance with one embodiment of the invention, a dispenser 10 for dispensing items 2, such as pet treats, comprises an upper housing 12 and a base 14. The upper housing 12 and the base 14 are adapted to be removably attachable to each other. The upper housing 12 generally defines, at least in part, an upper enclosure 16 for containing the items 2 to be dispensed by the dispenser 10.

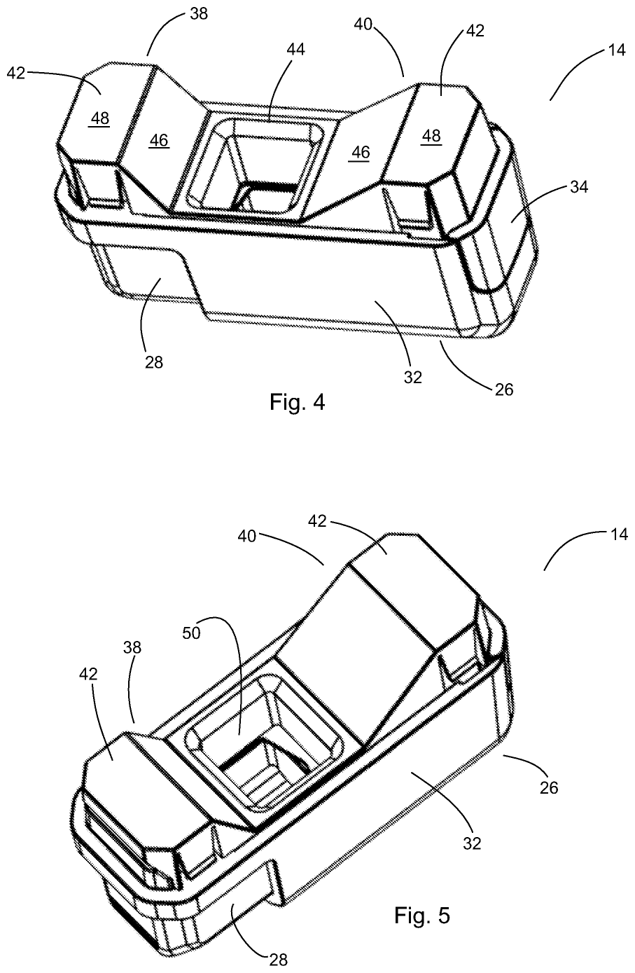

The upper housing 12 may be in a number of shapes; however, in one exemplary embodiment shown in FIGS. 2 and 3, the upper housing 12 comprises opposed upper sidewalls 18, opposed upper end walls 20, and a top wall 22. Preferably, the upper end walls 20 and the top wall 22 extend between the upper sidewalls 18. The top wall 22 and/or the upper end walls 20 may be at least partially curved, as shown in the embodiment of FIGS. 2 and 3. The upper enclosure 16 may be defined, at least in part, by the upper sidewalls 18, the upper end walls 20, and the top wall 22. Furthermore, the upper sidewalls 18 and the upper end walls 20 define, at least in part, an upper housing opening 24 on the upper housing 12 that leads to the upper enclosure 16. For example, the upper sidewalls 18 may comprise sidewall edges 116, and the upper end walls 20 may comprise end wall edges 118, with the sidewall edges 116 and the end wall edges 118 defining, at least in part, the upper housing opening 24. The upper housing opening 24 allows for the items 2 in the upper enclosure 16 to pass into the lower housing 14.

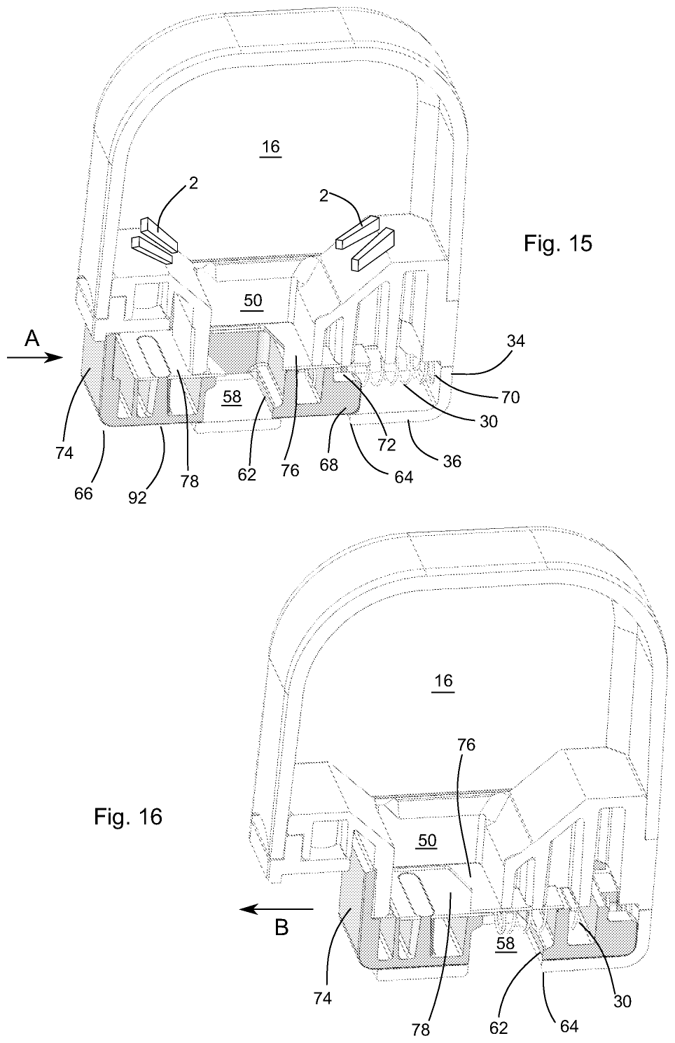

The base 14 is configured to receive the items 2 from the upper housing 12 and to dispense the items 2, as described as follows. Referring to FIGS. 4 to 7, the base 14 comprises a lower housing 26 and a dispensing member 28 that is adapted to slidably engage within the lower housing 26. The base 14 further comprises one or more spring members 30 that connect the lower housing 26 with the dispensing member 28. The dispensing member 28 is adapted to move between a first (closed) position and a second (open) position, with the spring members 30 normally biasing the dispensing member 28 to the first (closed) position. In the first (closed) position, the items 2 are prevented from exiting the base 14. In the second (open) position, the items 2 are allowed to exit the base 14 (i.e. the items 2 are dispensed from the base 14). FIG. 15 depicts the dispensing member 28 in the first (closed) position, while FIG. 16 depicts the dispending member 28 in the second (open) position.

Referring back to FIGS. 4 to 7, the lower housing 26 comprises opposed lower sidewalls 32, a lower end wall 34, and a bottom wall 36. Preferably, the bottom wall 36 and the lower end wall 34 extend between the lower sidewalls 32. The lower housing 26 preferably further comprises first and second housing members 38, 40 that are spaced apart from each other. He first and second housing members 38, 40 may extend between the lower sidewalls 32. Preferably, when the upper housing 12 is attached to the base 14, the first and second housing members 38, 40 extend partially into the upper enclosure 16. Each of the first and second housing members 38, 40 comprises an upper surface 42. When the upper housing 12 is attached to the base 14, the upper surfaces 42 of the first and second housing members 38, 40 provide a partial floor for the items 2 within the upper enclosure 16.

Referring again to FIGS. 4 to 7, an upper opening 44 is provided on the lower housing 26, preferably between the first and second housing members 38, 40. At least a portion of the upper surfaces 42 of the first and second housing members 38, 40 may be angled or curved such that at least some of the items 2 that contact the upper surfaces 42 are directed towards the upper opening 44. For example, in the embodiment shown in FIG. 4, each of the upper surfaces 42 comprises an angled surface 46 and a substantially planar surface 48, with the angled surface 46 directing and angling the items 2 towards the upper opening 44.

Instead of the upper surfaces 42 comprising a portion thereof that is angled, it is also possible that an entirety, or substantially an entirety, of the upper surfaces 42 is angled. Furthermore, it is also possible that at least a portion of the upper surfaces 42 is curved, rather than, or in addition to, being angled.

The lower housing 26 comprises a lower enclosure 50 that is located between the first and second housing members 38, 40. The lower enclosure 50 is also bound at one end by the upper opening 44 and at another end by a lower opening 52. Preferably, the upper opening 44 is at least partially aligned with the lower opening 52 (as shown, for example, in FIG. 9).

The lower enclosure 50 is generally contiguous with the upper enclosure 16 when the upper housing 12 is attached to the base 14. As a result, the items 2 from the upper enclosure 16 are able to enter into the lower enclosure 50 through the upper opening 44 and exit the lower enclosure 50 through the lower opening 52.

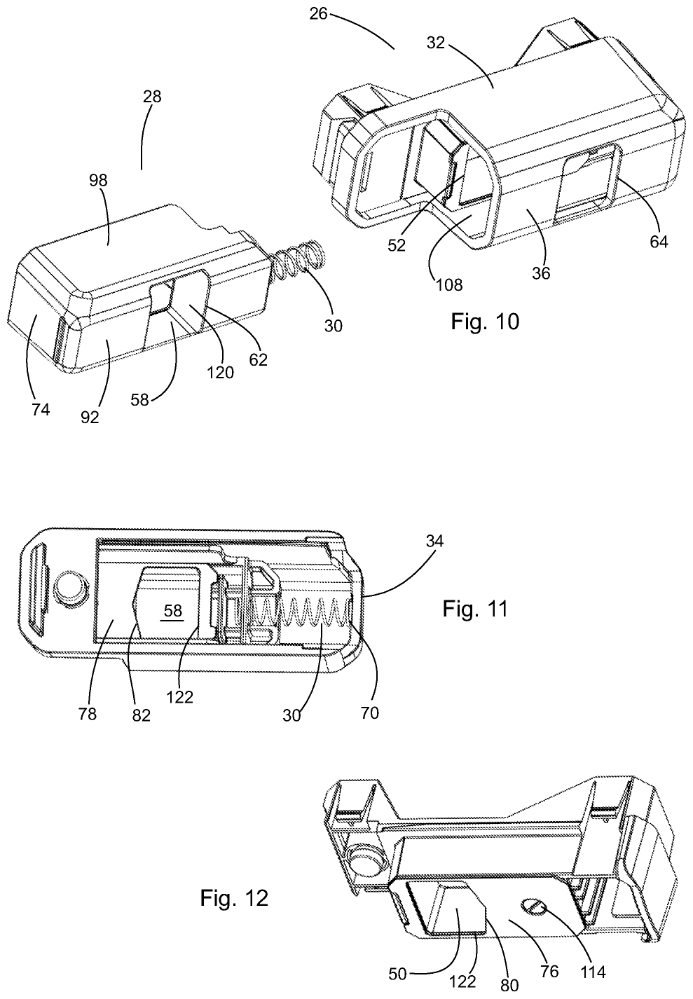

Referring to FIG. 10, the lower housing 26 comprises a channel 108 that is defined, at least in part, by portions of the lower sidewalls 32, the bottom wall 36, and the lower end wall 34. The channel 108 is adapted to accommodate the dispensing member 28 and to allow for movement of the dispensing member 28 therein, as described below.

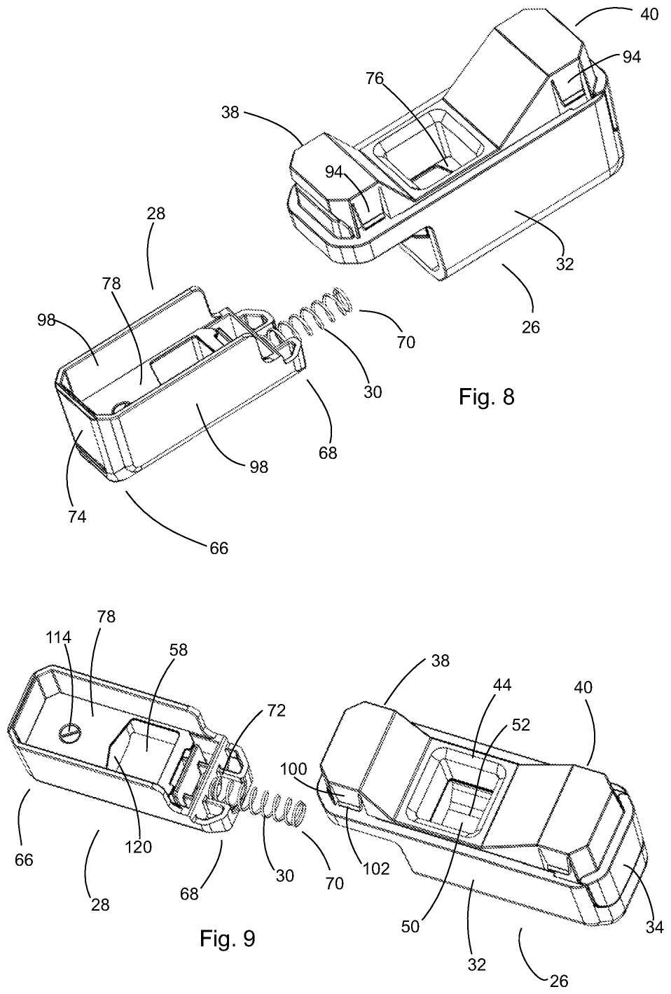

Referring to FIGS. 8 to 10, the dispensing member 28 comprises opposed dispenser sidewalls 98 that slidably engage with the lower sidewalls 32 when moving within the channel 108. The dispensing member 28 further comprises a dispenser floor 92 extending between the dispenser sidewalls 98. Furthermore, the dispensing member 28 may also comprise opposed interior walls 120 extending between the dispenser sidewalls 98.

The dispensing member 28 also comprises a dispenser enclosure 58 that is defined, at least in part, by the interior walls 120 and a portion of the dispenser sidewalls 98. The dispenser enclosure 58 is bound at one end by a dispenser upper opening 60 and at another end by a dispenser lower opening 62. The dispenser lower opening 62 is preferably formed on the dispenser floor 92.

Preferably, the dispenser upper and lower openings 60, 62 are at least partially aligned. Referring to FIG. 15, when the dispensing member 28 is in the first (closed) position, the lower enclosure 50 is generally contiguous with the dispenser enclosure 58 such that the items 2 in the lower enclosure 50 are able to move into the dispenser enclosure 58 through the lower opening 52 and the dispenser upper opening 60. In other words, when the dispensing member 28 is in the first (closed) position, the lower opening 52 and the dispenser upper opening 60 are at least partially aligned.

The bottom wall 36 comprises a bottom opening 64. When the dispensing member 28 is in the first (closed) position, the items 2 in the dispenser enclosure 58 are prevented from exiting the base 14 because the bottom wall 36 covers an entirety, or least substantially an entirety, of the dispenser lower opening 62, as shown in FIG. 15. However, when the dispensing member 28 is in the second (open) position, the dispenser lower opening 62 is aligned (or at least partially aligned) with the bottom opening 64 (as shown in FIG. 16), thereby allowing the items 2 located within the dispensing enclosure 58 to pass through the dispenser lower opening 62 and the bottom opening 64 to exit or drop from the base 14. In addition, when the dispensing member 28 is in the second (open) position, the lower opening 52 and the dispenser upper opening 60 are no longer aligned.

The bottom opening 64 is preferably not aligned with the upper or lower openings 44, 52.

In the embodiment shown in the drawings, the upper opening 44, the lower opening 52, the dispenser upper opening 60, the dispenser lower opening 62, and the bottom opening 64 are all substantially rectangular in shape; however, it is understood that one or more of them may be in other shapes (e.g. circular, elliptical, polygonal, etc.) as well. Furthermore, the upper opening 44, the lower opening 52, the dispenser upper opening 60, the dispenser lower opening 62, and the bottom opening 64 may all be of similar dimensions, or they may have differing dimensions from one another.

The spring members 30 normally biases the dispensing member 22 to the first (closed) position within the lower housing 26. The dispensing member 22 comprises first and second dispenser ends 66, 68. Each of the spring members 30 comprises first and second spring ends 70, 72. The spring members 30 are preferably connected to the lower end wall 34 proximate to the first spring end 70 and to the second dispenser end 68 proximate to the second spring end 72. In the embodiment shown in FIGS. 8 and 9, the one or more spring members 30 comprise a single spring member 30; however, it is understood that two or more spring members 30 are also possible.

When the spring members 30 are in their uncompressed state, the spring members 30 will bias the dispensing member 22 away from the lower end wall 34, into the first (closed position).

FIG. 15 shows the dispenser 10 in the first (closed) position. The dispensing member 28 preferably comprises a push surface 74 proximate to the first dispenser end 66. The push surface 74 is adapted to allow the user to exert pressure thereon in direction A (shown in FIG. 15), such as by pressing with a finger or a thumb. This pressure on the push surface 74 will tend to cause the spring members 30 to compress, thereby moving the dispensing member 28 longitudinally within the lower housing 26 (between the lower sidewalls 32) towards the lower end wall 34. If enough pressure is exerted on the push surface 74, the dispensing member 28 will be moved into the second (open) position (as shown in FIG. 16), such as when the dispenser lower opening 62 is substantially aligned with the bottom opening 64. Any of the items 2 within the dispenser enclosure 58 will thereby be released through the bottom opening 64, thereby dispensing the items 2.

FIG. 16 shows the dispenser 10 in the second (open) position. When the user no longer applies pressure on the push surface 74 (e.g. by releasing the finger or the thumb from the push surface 74), the release of the pressure exerted on the push surface 74 causes the spring members 30 to decompress, thereby moving the dispensing member 28 longitudinally within the lower housing 26 away from the lower end wall 34 in direction B (shown in FIG. 16). When the spring members 30 are fully decompressed, the dispensing member 28 will be moved back into the first (closed) position. The dispenser lower opening 62 is no longer substantially aligned with the bottom opening 64. Instead, the dispenser lower opening 62 is preferably substantially covered by the bottom wall 36, and the items 2 within the dispenser enclosure 58 are no longer able to exit or drop from the base 14.

The internal dimensions of the dispenser enclosure 58 may sometimes be insufficient to fully accommodate the size of the items 2 to be dispensed (e.g. pet treats). For example, when the dispensing member 28 is in the first (closed) position, if one of the items 2 has a length that is greater than a height of the dispenser enclosure 58, only a portion of the item 2 may fit within the dispenser enclosure 58, with the remaining portion of the item 2 extending into the lower enclosure 50. When the user attempts to the move the dispensing member 28 from the first (closed) position to the second (open) position, the dispensing member 28 may become jammed as the item 2 prevents the dispensing member 28 from fully moving to the second (open) position. For example, if a portion of the item 2 extends from the dispenser enclosure 58 into the lower enclosure 50, the item 2 may be caught within the lower opening 50 and the dispenser upper opening 60 when the dispensing member 28 is moved from the first (open) position to the second (closed) position.

To address this, dispenser 10 may comprise one or more blade members 54 that are adapted to cut the items 2 within the dispenser enclosure 58 that may be too large. Referring to FIG. 11 (which is a partial view of the base 14 showing the dispensing member 28 and a lower portion of the lower housing 26) and to FIG. 12 (which is another partial view of the base 14 showing an upper portion of the lower housing 26), the blade members 54 may comprise first and second blade members 76, 78.

The first blade member 76 is preferably rigidly attached to the lower housing 26 and extends proximate to the lower opening 52 (best seen in FIG. 12). The first blade member 76 may be attached to the lower housing 26 using any suitable means, including fasteners or adhesives. For example, in the embodiment shown in FIG. 12, the first blade member 76 may be attached to the lower housing 26 using screws 114. Preferably, at least a portion of the first blade member 76 extends into and/or across the lower opening 52. The first blade member 76 comprises a first cutting edge 80 that extends, at least partially, across the lower opening 52. The first cutting edge 80 may take a number of forms, including V-shaped (as shown in FIG. 12), straight, curved, or a combination thereof. Preferably, the first blade member 76 extends only partially into the lower opening 52 such that items in the lower enclosure 50 are not prevented from entering into the dispenser enclosure 58 through the lower opening 52 when the dispensing member 28 is in the first (closed) position.

The second blade member 78 is preferably rigidly attached to the dispensing member 28 and extends proximate to the dispenser upper opening 60 (best seen in FIG. 11). The second blade member 78 may be attached to the dispensing member 28 using any suitable means, including fasteners or adhesives. For example, the second blade member 78 may be attached to the dispensing member 28 using screws 114 (best seen in FIG. 9). Preferably, at least a portion of the second blade member 78 extends into and/or across the dispenser upper opening 60. The second blade member 78 comprises a second cutting edge 82 that extends, at least partially, across the dispenser upper opening 60. The second cutting edge 82 may take a number of forms, including V-shaped (as shown in FIG. 11), straight, curved, or a combination thereof. Preferably, the second blade member 78 extends only partially into the dispenser upper opening 60 such that items in the lower enclosure 50 are not prevented from entering into the dispenser enclosure 58 through the dispenser upper opening 60 when the dispensing member 28 is in the first (closed) position.

In the embodiment shown in FIGS. 11 and 12, the first and second blade members 76, 78 are substantially rectangular in shape (best seen in FIG. 14) and comprise an interior window 122. The first or second cutting edges 80, 82 preferably form one side of the window 122.

When the dispensing member 28 is moved from the first (closed) position to the second (open) position, the first and second blade members 76, 78 are configured such that the second blade member 78 will slide over and across the first blade member 76 as the dispensing member 28 is moved towards the lower end wall 34. Preferably, the first and second blade member 76, 78 are positioned such that when the dispensing member 28 is moved from the first (closed) position to the second (open) position (and vice versa), the second cutting edge 82 will slide past the first cutting edge 80.

Any of the items 2 that are within the dispenser enclosure 58 but extend into the lower enclosure 50 will be severed by the sliding of the second cutting edge 82 past the first cutting edge 80.

Although the embodiment shown in FIGS. 11 and 12 depicts the first and second blade members 76, 78, it is understood that one of the first and second blade members 76, 78 may be omitted from the dispenser 10 while still providing cutting ability. However, the use of both of the first and second blade members 76, 78 provides improved cutting ability compared to when only one of the first or second blade members 76, 78 is provided.

By providing at least one of the first or second blade members 76, 78, the items 2 that are of larger sizes (i.e. longer than a height of the dispenser enclosure 58) may be used with the dispenser 10 without the dispensing member 28 jamming when dispensing the items 2.

Referring to FIGS. 2 and 3, one or both of the upper sidewalls 18 may comprise a transparent or semi-transparent window 84. The window 84 allows the user to view, at least partially, the contents of the upper enclosure 16. In one embodiment, the upper sidewalls 18 comprises a window opening 86, across which the window 84 may be fixedly attached.

Furthermore, the upper housing 12 may further comprise a belt clip 88 that may be attached to one of the upper sidewalls 18. The belt clip 88 is configured to allow the dispenser 10 to be removably attached to a belt or another suitable article of clothing worn by the user, allowing the dispenser 10 to be carried about without being necessarily held by hand.

Preferably, the upper housing 12 is configured to be removably attachable to the lower housing 26 so as to allow the dispenser 10 to be refilled with the items 2 from time to time. The attachment may be by way of friction fitting, mechanical fasteners, retaining tabs, or any other suitable mechanism. For example, in the embodiment shown in FIGS. 1 to 10, the upper housing 12 comprises one more inward-facing protrusions 90. The tabs 90 may be located on the upper sidewalls 18 and/or the upper end walls 20 proximate to the upper housing opening 24. The protrusions 90 are configured to engage with corresponding ones of tabs 94 located on the lower housing 26. Preferably, the tabs 94 may be located on the first and/or second housing members 38, 40.

For example, in the embodiment shown in FIGS. 1 to 10, the tabs 94 comprise a strip portion 100 and an angled tip 102. When the protrusions 90 come into contact with the angled tip 102 (such as when the upper housing 12 is to be attached to the lower housing 26), further pressure on the protrusions 90 against the angled tips 102 will cause the strip portions 100 to deflect inwards. The protrusions 90 are able to slide past the angled tips 102. When the protrusions 90 have slid past the angled tips 102, the strip portions 100 will revert back to their original configuration. The upper housing 12 is secured to the lower housing 26, as the engagement of the protrusions 90 against the angled tips 102 prevent the upper housing 12 from being easily detached from the lower housing 26.

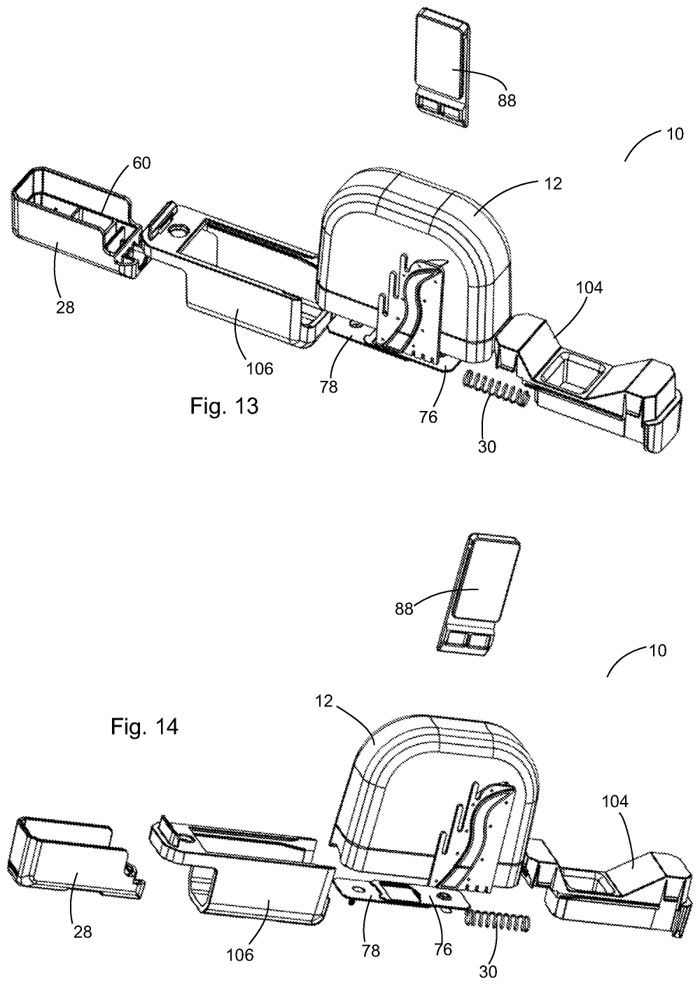

In one embodiment, the lower housing 26 may comprise may comprise first and second portions 104, 106 that are removably attached together. In other embodiments, the first and second portions 104, 106 may be fixedly attached together or may form a unitary piece. FIGS. 13, 14, 17, and 18 depicts the first and second portions 104, 106 that form the lower housing 26. In embodiments where the first and second portions 104, 106 are removably attached together, they may be held together by way of friction fitting, mechanical fasteners, retaining tabs, or any other suitable means.

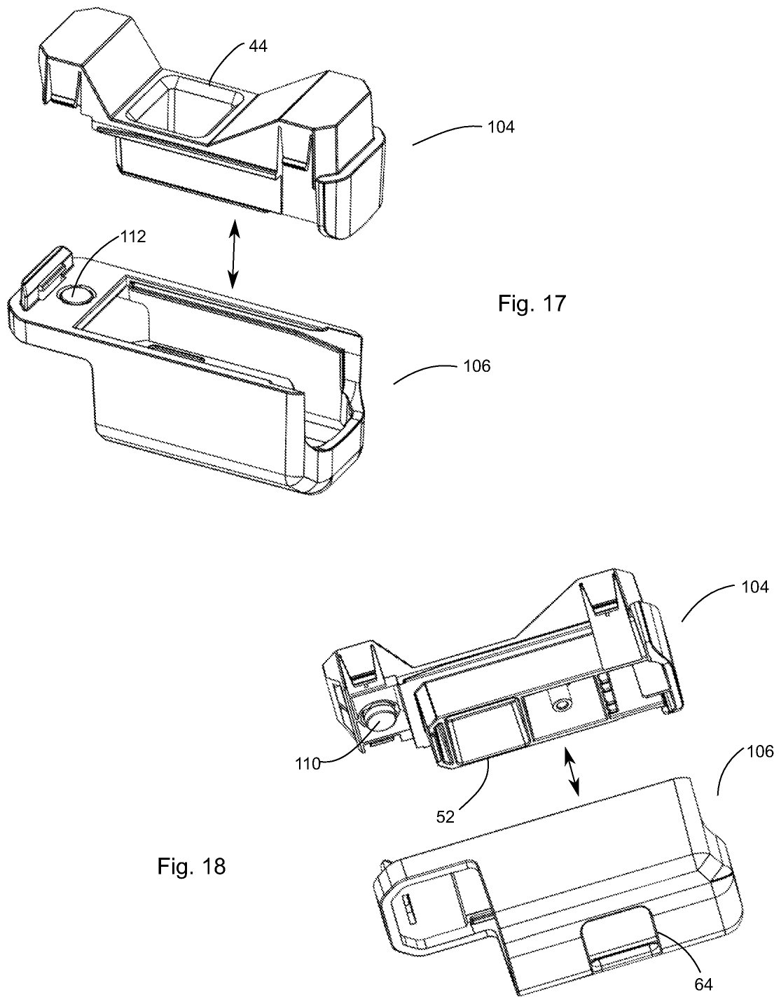

In the embodiment shown in FIGS. 17 and 18, the lower housing 26 comprises a first connector 110 fixedly attached to the first portion 104, and a second connector 112 fixedly attached to the second portion 106. The first connector 110 is adapted to removably attach to the second connector 112, thereby allowing the first portion 104 to be removably attached to the second portion 106. For example, the first and second connectors 110, 112 may be magnetic. The removable attachment of the first and second portions 104, 106 allow for the lower housing 26 to be more easily cleaned.

The dispenser 10 described herein is intended to be portable (i.e. carried by the user).

In order to load the dispenser 10 with the items 2, the upper housing 12 is first detached from the base 14, and the upper housing 12 is then inverted. The items 2 may be loaded into the upper enclosure 16 through the upper housing opening 24. While the upper housing 12 is still inverted, the base 14 can be re-attached to the base 14. The upper housing 12 and the attached base 14 can then be placed back into their upright orientation (i.e. as in FIG. 1). The items 2 can then be dispensed through the bottom opening 64 as described above.

It will be appreciated by those skilled in the art that the preferred embodiments have been described in some detail but that certain modifications may be practiced without departing from the principles of the invention.

1. A dispenser for dispensing items, the dispenser comprising:
an upper housing adapted to enclose the items; and
a base removably attached to the upper housing, the base comprising:
a lower housing comprising:
a lower enclosure comprising an upper opening at one end thereof and a lower opening at another end thereof, the upper opening adapted to receive the items from the upper housing into the lower enclosure;
a first blade member extending across at least a portion of the lower opening; and
a bottom wall comprising a bottom opening formed thereon, the bottom opening not in alignment with the lower opening;
a dispensing member adapted to move longitudinally within the lower housing, the dispensing member comprising:
a dispenser enclosure comprising a dispenser upper opening at one end thereof and a dispenser lower opening at another end thereof; and
a second blade member extending across at least a portion of the dispenser upper opening;
one or more spring members connecting the dispensing member to the lower housing, the one or more spring members adapted to allow the dispensing member to move from a first position to a second position, and vice versa, with respect to the lower housing;
wherein in the first position, the lower opening is, at least partially, aligned with the dispenser upper opening to allow the items to enter into the dispenser enclosure from the lower enclosure; and
wherein in the second position, the dispenser lower opening is, at least partially, aligned with the bottom opening to allow the items to exit from the dispenser enclosure through dispenser lower opening and the bottom opening.

2. The dispenser of claim 1, wherein a movement of the dispensing member from the first position to the second position causes the second blade member to slide past the first blade member and to sever any of the items that are within both of the lower enclosure and the dispenser enclosure.

3. The dispenser of claim 1, wherein the lower housing further comprises first and second housing members, and wherein the lower enclosure is located between the first and second housing members.

4. The dispenser of claim 3, wherein the first and second housing members comprise upper surfaces, and wherein the upper surfaces are adapted to direct the items towards the upper opening.

5. The dispenser of claim 4, wherein the upper surfaces comprise one or more angled surfaces.

6. The dispenser of claim 4, wherein the upper surfaces comprise one or more curved surfaces.

7. The dispenser of claim 1, wherein the upper opening is, at least partially, aligned with the lower opening.

8. The dispenser of claim 1, wherein the dispenser upper opening is, at least partially, aligned with the dispenser lower opening.

9. The dispenser of claim 1, wherein the lower housing further comprises a channel adapted to accommodate the dispensing member, wherein the dispensing member is adapted to move from the first position to the second position, and vice versa, through longitudinal movement within the channel.

10. The dispenser of claim 1, wherein the one or more spring members bias the dispensing member to the first position when the one or more spring members are uncompressed.

11. The dispenser of claim 10, wherein a compression of the one or more spring members causes the dispensing member to move from the first position to the second position.

12. The dispenser of claim 9, wherein the lower housing further comprises:
opposed lower sidewalls; and
a lower end wall extending between the lower sidewalls;
wherein the bottom wall extends between the lower sidewalls; and
wherein the channel is defined, at least in part, by portions of the lower sidewalls, the bottom wall, and the lower end wall.

13. The dispenser of claim 12, wherein the one or more spring members comprise first and second spring ends, wherein the first spring ends are connected to the lower end wall, and wherein the second spring ends are connected to the dispensing member.

14. The dispenser of claim 2, wherein the first blade member comprises a first cutting edge, wherein the second blade member comprises a second cutting, and wherein the movement of the dispensing member from the first position to the second position causes the second cutting edge to slide past the first cutting edge.

15. A dispenser for dispensing items, the dispenser comprising:
an upper housing adapted to enclose the items; and
a base removably attached to the upper housing, the base comprising:
a lower housing comprising:
a lower enclosure comprising an upper opening at one end thereof and a lower opening at another end thereof, the upper opening adapted to receive the items from the upper housing into the lower enclosure; and
a bottom wall comprising a bottom opening formed thereon, the bottom opening not in alignment with the lower opening;
a dispensing member adapted to move longitudinally within the lower housing, the dispensing member comprising:
a dispenser enclosure comprising a dispenser upper opening at one end thereof and a dispenser lower opening at another end thereof; and
a blade member extending across at least a portion of the dispenser upper opening;
one or more spring members connecting the dispensing member to the lower housing, the one or more spring members adapted to allow the dispensing member to move from a first position to a second position, and vice versa, with respect to the lower housing;
wherein in the first position, the lower opening is, at least partially, aligned with the dispenser upper opening to allow the items to enter into the dispenser enclosure from the lower enclosure; and
wherein in the second position, the dispenser lower opening is, at least partially, aligned with the bottom opening to allow the items to exit from the dispenser enclosure through dispenser lower opening and the bottom opening.

16. The dispenser of claim 15, wherein a movement of the dispensing member from the first position to the second position causes the blade member to slide across the lower opening and to sever any of the items that are within both of the lower enclosure and the dispenser enclosure.

17. The dispenser of claim 16, wherein the blade member comprises a cutting edge, and wherein the movement of the dispensing member from the first position to the second position causes the cutting edge to slide across the lower opening.

18. A dispenser for dispensing items, the dispenser comprising:
an upper housing adapted to enclose the items; and
a base removably attached to the upper housing, the base comprising:
a lower housing comprising:
a lower enclosure comprising an upper opening at one end thereof and a lower opening at another end thereof, the upper opening adapted to receive the items from the upper housing into the lower enclosure;
a blade member extending across at least a portion of the lower opening; and
a bottom wall comprising a bottom opening formed thereon, the bottom opening not in alignment with the lower opening;
a dispensing member adapted to move longitudinally within the lower housing, the dispensing member comprising a dispenser enclosure comprising a dispenser upper opening at one end thereof and a dispenser lower opening at another end thereof; and
one or more spring members connecting the dispensing member to the lower housing, the one or more spring members adapted to allow the dispensing member to move from a first position to a second position, and vice versa, with respect to the lower housing;
wherein in the first position, the lower opening is, at least partially, aligned with the dispenser upper opening to allow the items to enter into the dispenser enclosure from the lower enclosure; and
wherein in the second position, the dispenser lower opening is, at least partially, aligned with the bottom opening to allow the items to exit from the dispenser enclosure through dispenser lower opening and the bottom opening.

19. The dispenser of claim 18, wherein a movement of the dispensing member from the first position to the second position causes the blade member to slide across the dispenser upper opening and to sever any of the items that are within both of the lower enclosure and the dispenser enclosure.

20. The dispenser of claim 19, wherein the blade member comprises a cutting edge, and wherein the movement of the dispensing member from the first position to the second position causes the cutting edge to slide across the dispenser upper opening.
